(19) United States
(12) Patent Application Publication
(10) Pub. No.: US 2006/0028954 A1
(43) Pub. Date: Feb. 9, 2006

(54) Illuminator device, non-spherical lens design method, non-spherical lens and projector

(75) Inventor: Susumu Aruga, Suwa-gun (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/130,196

(22) Filed: May 17, 2005

(30) Foreign Application Priority Data
Jul. 15, 2004 (JP) 2004-208514

(51) Int. Cl. G11B 7/00

(52) U.S. Cl. 369/100

(57) ABSTRACT

Exemplary embodiments of the invention provide an illuminator device including a light source for emitting light to be irradiated to an irradiation plane; a first optical system provided between the light source and the irradiation plane to make the light emitted from the light source into collimated light; and a second optical system provided between the first optical system and the irradiation plane to converge the collimated light to the irradiation plane such that aberration occurs on an image of the collimated light in a predetermined region of the irradiation plane.

### BACKGROUND

Exemplary embodiments of the invention relate to a non-spherical lens to converge light emitted from a light source to an irradiation plane. Exemplary embodiments further provide a method of designing such a non-spherical lens, an illuminator device to illuminate light to an irradiation plane and a projector mounted with such an illuminator device.

A direct-view or projection display device, (projector) using a liquid-crystal panel as a light modulator, requires a light source to illuminate light to the liquid-crystal panel. Related art document JP-A-10-269802 discloses that light emitted from a light source, e.g. light-emitting diode is collimated into collimated light that is to be converted toward a liquid-crystal panel, thereby illuminating the light to the liquid crystal panel. When adopting such a structure as in related art document JP-A-10-269802, aberration possibly occurs in an image formed on the liquid-crystal panel under a certain design of the optical system. As such, the illumination efficiency is lowered because of blurred light to be illuminated as a light source. The lowered illumination efficiency worsens the contrast of an image, a motion image or the like projected, for example, to the screen. Therefore, there is a need to design an optical system that reduces aberration furthermore.

As aberration decreases, the optical system is made more approximate to an enhanced or the ideal image-forming system. For an enhanced or the ideal image-forming system that does not require consideration of the effect of aberration, illumination efficiency is decided by the magnification based on the relevant optical system. Accordingly, when illumination efficiency is enhanced or improved, the optical system may be made approximate to an enhanced or the ideal image-forming system, thereby optimizing the magnification thereof.

However, because the illumination efficiency on the above design could not be increased higher than the illumination efficiency of the optical system made having an enhanced or the ideal image-forming system and optimal magnification, illumination efficiency enhancement or improvement is limited by the value of the illumination efficiency in that case.

### SUMMARY

Exemplary embodiments of the invention provide an illuminator device, design method of a non-spherical lens for use on such an illuminator device, and non-spherical lens and projector mounted with such an illuminator device. Accordingly, illumination efficiency can be enhanced or improved higher than that of an enhanced or the ideal image-forming system structure by making up an optical system to positively cause aberration in an image on the liquid-crystal panel.

The inventor has found that the optical system, if designed to positively cause an aberration in a predetermined region of the irradiation plane upon converging collimated light to the irradiation plane, provides higher illumination efficiency at the irradiation plane as compared to the case of designing the optical system on the image-forming system.

Here, the non-spherical lens has a surface that can be considered as a non-spherical surface formed by rotating about a Z axis, a curved line on a YZ plane. The curved line on the YZ plane is expressed by the following equation.

$$z = \frac{{ch}^{2}}{1 + {\{ 1 - ( 1 + k ) {C}^{2} {h}^{2} \}}^{\frac{1}{2}}} + {a}_{1} {h}^{4} + {a}_{2} {h}^{6} + {a}_{3} {h}^{8} + {a}_{4} {h}^{10} \qquad [ Equation 1 ]$$

h is a square root of the sum √(x²+y²) while x, y and z are variables representing a coordinate on the XYZ space. Meanwhile, C, k, a₁, a₂, a₃ and a₄ are non-spherical coefficients. The lower order non-spherical coefficients (e.g. C, k, a₁, a₂) contribute to the form of the non-spherical surface lens at its axis and around. The higher order non-spherical coefficients (e.g. a₃, a₂) contribute to the form of the non-spherical surface lens at its periphery. Accordingly, by suitably establishing the higher order non-spherical coefficients of [Equation 1], the peripheral form of the non-spherical lens can be designed. By suitably establishing the lower order non-spherical coefficients, the non-spherical lens can be designed in its form at around the optical axis thereof.

Accordingly, an illuminator device of exemplary embodiments of the invention includes: a light source to emit light to be irradiated to an irradiation plane; a first optical system provided between the light source and the irradiation plane to make the light emitted from the light source into collimated light; and a second optical system provided between the first optical system and the irradiation plane to converge the collimated light to the irradiation plane such that aberration occurs on an image of the collimated light in a predetermined region of the irradiation plane.

Here, the “predetermined region” refers to an area, of the irradiation plane, highly requiring to be irradiated with light. For example, where to irradiate light to a liquid-crystal panel, the “irradiation plane” is a surface on a light-irradiated side of the liquid-crystal panel, and the “predetermined region” is a pixel region forming pixels of a liquid-crystal panel.

The illumination efficiency does not enhance or improve without irradiating light, at an angle smaller than an allowable angle, to the predetermined region of the irradiation plane. According to exemplary embodiments of the invention, the light emitted from the light source is collimated at the first optical system and then focused by the second optical system such that an aberration occurs on an image of the collimated light in a predetermined region of the irradiation plane. By positively causing an aberration in the predetermined region of the irradiation plane, it is possible to decrease the angle of the light irradiated to the predetermined region of the irradiation plane. Therefore, because of an increase of the light to be irradiated at the allowable angle or smaller to the predetermined region, illumination efficiency can be increased in the predetermined region of the irradiation plane.

Meanwhile, preferably, the second optical system is allowed to converge the collimated light so that the aberration can occur over a broader range than the predetermined region. This can provide a sufficient illumination margin to the predetermined region of the irradiation plane. For example, where irradiating light to a liquid-crystal panel, light is to be impinged upon all the pixels without fail.

Meanwhile, preferably, the aberration is at least one of negative spherical aberration and introvert coma aberration. Because negative spherical aberration and introvert coma aberration are each formed in a manner spreading over the irradiation plane, light can be impinged uniformly upon the predetermined region of the irradiation plane.

Meanwhile, preferably, the second optical system is a lens designed to include a major plane thereof at least around an optical axis thereof. By structuring the second optical system with such a lens, the light passing nearby the optical axis of the lens causes an introvert coma aberration. By thus positively forming a coma aberration, illumination efficiency is enhanced or improved in the predetermined region.

Meanwhile, preferably, the optical system including the first and second optical systems is a telecentric optical system. Such a system can decrease the angle of the major ray of the collimated light that is converged by the second optical system to the predetermined region of the irradiation plane, thus further enhancing or improving the illumination efficiency.

Exemplary embodiments provide a method of designing a non-spherical lens to converge light, emitted from a light source and collimated, to an irradiation plane. The method includes: designing a non-spherical form such that aberration occurs on an image of the collimated light in a predetermined region of the irradiation plane.

By designing a non-spherical form as in exemplary embodiments of the invention, it is possible to obtain a non-spherical lens capable of focusing light in a manner causing an aberration in a predetermined region of the irradiation plane. Specifically, the peripheral form is designed for the non-spherical lens by properly establishing the higher order non-spherical coefficients of the above [Equation 1]. The form nearby the optical axis is designed for the non-spherical lens by properly establishing the lower order non-spherical coefficients.

Meanwhile, preferably a method of designing a non-spherical lens according another aspect of exemplary embodiments of the invention, further includes forming a spherical lens having a predetermined paraxial magnification, allowable angle and focal length; and deforming the spherical lens so that aberration can occur on an image based on the collimated light converged, in a predetermined region of the irradiation plane. Designing is based on spherical lens values as references, in terms of non-spherical lens paraxial magnification, allowable angle and focal length. Accordingly, precise values can be obtained even unless designing a paraxial magnification, allowable angle and focal length for the non-spherical lens from the beginning.

Meanwhile, preferably, deforming the spherical lens includes deforming the spherical lens to incline the major plane of the spherical lens and deforming the spherical lens in a manner of returning the inclination of the major plane at a periphery of the deformed spherical lens. This can suppress the major plane of the non-spherical lens from inclining excessively and reduce or prevent a coma aberration from being formed beyond the predetermined region. Thus, coma aberration can be caused in a preferred range in the predetermined region of the irradiation plane.

A non-spherical lens according to another exemplary aspect of the invention is characterized by being designed according to the spherical lens designing method. This can obtain a non-spherical lens capable of causing an aberration in the predetermined region of the irradiation plane and converging collimated light in a manner raising the illumination efficiency higher on the irradiation plane as compared to that of an enhanced or the ideal image-forming system.

A projector according to another exemplary aspect of the invention is characterized by mounting the illuminator device. This can obtain a projector high in illumination efficiency and contrast.

### BRIEF DESCRIPTION OF THE DRAWINGS

Exemplary embodiments of the invention will be described with reference to the accompanying drawings, wherein like numbers reference like elements, and wherein:

FIG. 1 is a schematic showing a structure outline of a projector according to an exemplary embodiment of the invention;

FIG. 2 is a schematic showing a structure outline of a non-spherical lens in the exemplary embodiment;

FIGS. 3(a) and 3(b) are schematics showing a traveling route of the light transmitted through the non-spherical lens in the exemplary embodiment;

FIGS. 4(a) and 4(b) are spot diagrams of the light converged by the non-spherical lens;

FIG. 5 is a graph representing a spherical aberration based on the non-spherical lens;

FIG. 6 is a flowchart showing a design process for a non-spherical lens in the exemplary embodiment;

FIG. 7 is a schematic showing one example of non-spherical lens design process;

FIG. 8 is a schematic showing one example of non-spherical lens design process;

FIG. 9 is a schematic showing one example of non-spherical lens design process;

FIG. 10 is a schematic showing one example of non-spherical lens design process; and

FIG. 11 is a schematic showing an exemplary modification to the projector according to exemplary embodiments of the invention.

### DETAILED DESCRIPTION OF EMBODIMENTS

### First Exemplary Embodiment

With reference to the drawings, a first exemplary embodiment of the invention will now be explained.

FIG. 1 is a schematic showing a structural outline of a projector in the present exemplary embodiment.

A projector 1 is constructed as a liquid-crystal projector of a single-plate type. This includes a illuminator device 2 having a light source 3, a rod integrator 4, a first optical system 5 and a non-spherical lens 6, a liquid-crystal device 7 as a modulator element, and a projection system 100 for projecting an image or the like to a screen, not shown.

The illuminator device 2 serves as a light source for the liquid-crystal device 7 by projecting light to the liquid-crystal device 7. The liquid-crystal device 7 has a pixel region 7a formed with pixels for three colors, e.g. red, green and blue, to modulate the irradiation light depending upon an image signal inputted from a drive section, not shown.

The light source 3 uses a light-emitting diode for example, and has a light-emitting surface 3a formed nearly square to emit light from the light-emitting diode to the outside. The light source 3 is attached on the rod integrator 4 such that the light-emitting surface 3a faces a light-incident surface 4a of the rod integrator 4.

The rod integrator 4 is to make uniform the illuminance distribution of the light incident upon the light-incident surface 4a, allowing it to exit at a light-exit surface 4b. This is formed of a light-transmissive material, such as glass or resin, in the form of a hollow, quadrangular prism. The rod integrator 4 is provided with reflection surfaces 4c at its inner side surfaces. The reflection surfaces 4c are provided such that the light-transmitting region (hollow region) has a sectional area gradually increasing from the light-incident surface 4a toward the light-exit surface 4b (broken line in FIG. 1).

The light-incident surface 4a is made nearly square such that its form is coincident with a form of the light-exit surface 3a of the light source 3. The light-exit surface 4b is made in a form coincident with a form of the pixel region 7a of the liquid-crystal device 7. For example, provided that the pixel region 7a is in a rectangular of (shorter side length):(longer side length)=3:4, the light-exit surface 4b is formed similarly in a rectangular having a ratio in length of shorter side and longer side of 3:4. The light entered the rod integrator 4 is guided to the light-exit surface 4b while repeatedly reflected upon the reflection surfaces 4c, thus exiting it in a state uniformed in illuminance distribution.

The first optical system 5 has a plurality of, e.g. two, meniscus lenses 5a, 5b and a collimator lens 5c. The meniscus lenses 5a, 5b are to diffuse the light exiting the rod integrator 4. The collimator lens 5c makes the diffusion light parallel into collimated light. The meniscus lenses 5a, 5b and the collimator lens 5c are formed of a transparent material, e.g. glass or acryl.

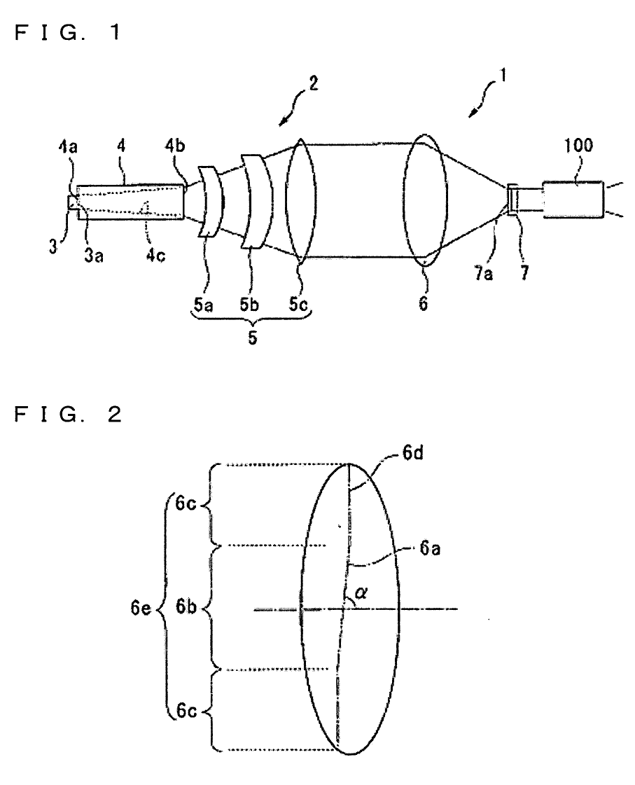

The non-spherical lens 6 is formed of a transparent material, e.g. glass or acryl, to converge the light collimated by the collimator lens 5c toward the pixel region 7a of the liquid-crystal device 7. FIG. 2 is a schematic showing an outline of the non-spherical lens. This is designed such that, at around the optical axis 6b of the non-spherical lens 6, the lens major plane 6a inclines, for example, an angle α relative to the traveling direction of the collimated light of from the collimator lens 5c. Meanwhile, design is also made such that, at the periphery 6c, the major plane 6d is nearly vertical to the traveling direction of the collimated light of from the collimator lens 5c.

Here, the non-spherical lens 6 has a non-spherical surface 6e that can be considered as a non-spherical surface formed by rotating an on-YZ-plane curved line about Z axis. The curved-line on YZ plane is expressed by the following equation.

$$z = \frac{{Ch}^{2}}{1 + {\{ 1 - ( 1 + k ) {C}^{2} {h}^{2} \}}^{\frac{1}{2}}} + {a}_{1} {h}^{4} + {a}_{2} {h}^{6} + {a}_{3} {h}^{8} + {a}_{4} {h}^{10} \qquad [ Equation 2 ]$$

h is a square root of the sum √(x²+y²) while x, y and z are variables representing a coordinate on the XYZ space. C, k, a₁, a₂, a₃ and a₄ are non-spherical coefficients. The lower order non-spherical coefficients (e.g. C, k, a₁, a₂) contribute to the form at around the optical axis 6b of the non-spherical surface lens while the higher order non-spherical coefficients (e.g. a₃, a₄) contribute to the form at a periphery 6c of the non-spherical surface lens.

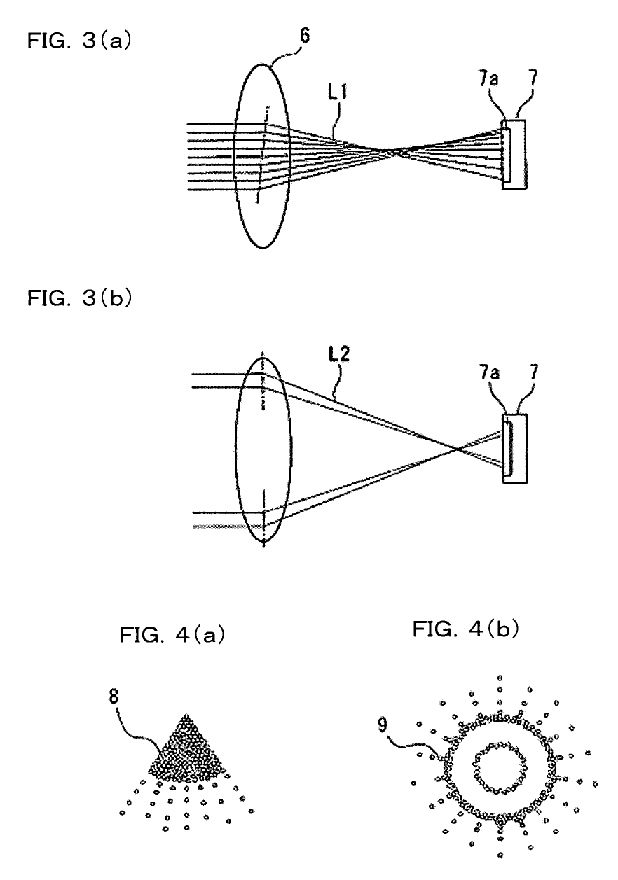

FIGS. 3(a)-3(b) show a traveling route of the light transmitted through the non-spherical lens 6. FIGS. 4(a)-(b) show a spot diagram formed on the pixel region 7a.

The light emitted from the light source 3 is diffused and collimated at the first optical system. The collimated light, upon passing nearby the optical axis 6b of the non-spherical lens 6, travels as along an optical path L1 (FIG. 3(a)) and causes an introvert coma aberration 8 at a peripheral area of the pixel region 7a (FIG. 4(a)).

Meanwhile, the collimated light, upon passing the periphery 6c of the non-spherical lens 6, travels as along an optical path L2 (FIG. 3(b)) and causes a negative spherical aberration 9 at around the center of the pixel region 7a (FIG. 4(b)).

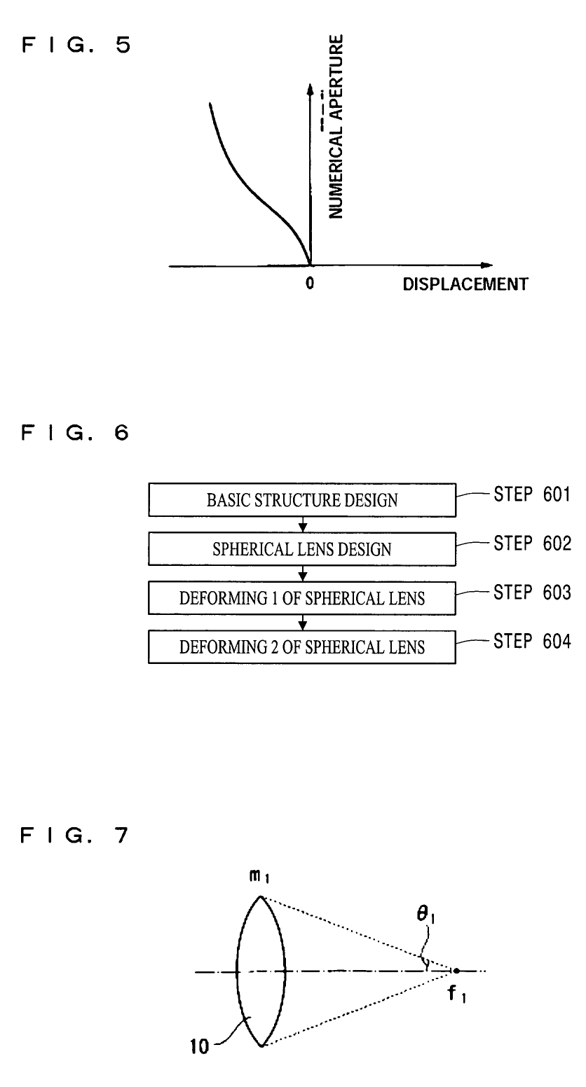

FIG. 5 is a graph representing a spherical aberration 9 due to the non-spherical lens 6. The origin represents a light-center position at the spherical lens 6, the ordinate a numerical aperture and the abscissa a displacement in the direction of traveling light. From the graph, it can be seen that spherical aberration 9 takes place not only at around the center of the pixel region 7a but also at the periphery of the pixel region 7a, where coma aberration 8 is formed.

In this manner, coma aberration 8 and spherical aberration 9 are formed on the pixel region 7a in a manner covering the pixel region 7a.

The design procedure is now explained for the non-spherical lens 6. FIG. 6 is a flowchart showing the design procedure.

The non-spherical lens 6 is formed out of a spherical lens 10. Design is conducted through the procedure including basic structural design of a spherical lens 10 (step 601), forming a spherical lens 10 (step 602), deforming 1 of the spherical lens 10 (step 603) and deforming 2 of the spherical lens 10 (step 604). The procedure is now explained below.

At step 601, design is made as to the basic structure of a spherical lens 10 as a basis of a non-spherical lens 6, as shown in FIG. 7. By establishing a paraxial magnification m₁, an allowable angle θ₁ and a focal length f₁, a spherical lens 10 is formed to the design.

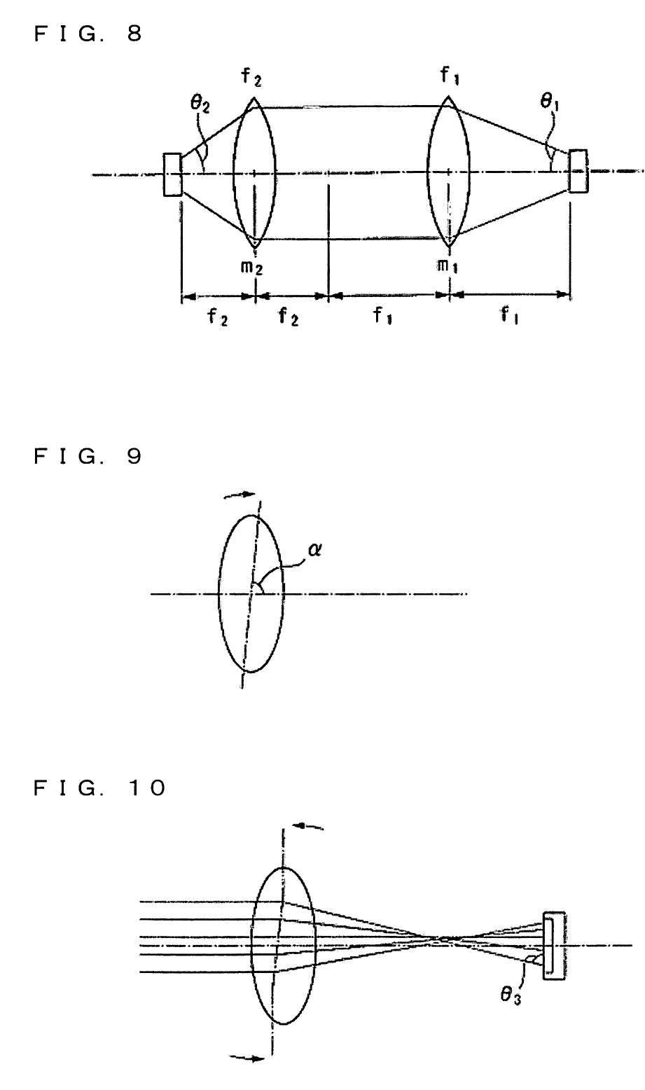

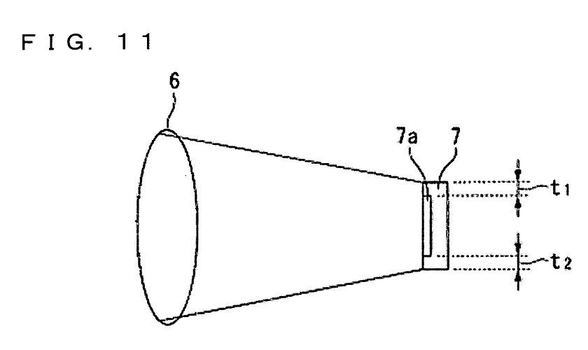

At step 602, an optical system is formed using the spherical lens 10. In this case, the light source 3, the first optical system 5 and the spherical lens 10 are arranged such that, for example, the distance between the collimator lens 5c (paraxis magnification m₂, allowable angle θ₂, focal length f₂) and the spherical lens 10 is given as (f₁+f₂) as shown in FIG. 8, in order to make the relevant optical system approximate to an enhanced or the ideal image-forming system.

At step 603, the lower order non-spherical coefficients mainly are established to deform the spherical lens 10 and cause a coma aberration 8. Specifically, deformation is made on the spherical surface nearby the optical axis 6b of the optical lens 10. Coma aberration occurs when light enters the optical system obliquely to the optical axis thereof. Accordingly, the spherical lens 10 is deformed to incline the major plane 6a relative to the collimated light of from the first optical system 5, for example as shown in FIG. 9. Also, the spherical lens 10 is deformed while confirming whether or not there is an occurrence of coma aberration 8 by actually emitting light from the light source 3. When confirmed an occurrence of coma aberration 8, the process moves to the next step.

At step 604, the higher order non-spherical coefficients mainly are established to deform the spherical lens 10 deformed at the step 603 while making a fine adjustment. Specifically, by emitting light from the light source 3, it is confirmed whether or not there is an occurrence of coma aberration 8 in a proper position and range. Simultaneously, the higher order non-spherical coefficients are adjusted to place the angle of the major ray within the allowable angle θ₃. By adjusting the inclination of the major plane 6d at the periphery 6c of the deformed spherical lens 10 as required, coma aberration 8 is reduced or prevented from occurring excessively. The design is completed by confirming the occurrence of a coma aberration 8 in a proper position and range wherein the angle of the main ray is within the allowable angle θ₃ as shown in FIG. 10.

According to the present exemplary embodiment, the light emitted from the light source 3 is collimated at the first optical system 5 and then focused by the non-spherical lens 6 in a manner causing a coma aberration 8 and spherical aberration 9 in the image of collimated light on the pixel region 7a of the liquid-crystal device 7. By focusing the light in a manner positively causing an aberration on the pixel region 7a, the angle (angle to the optical axis) can be decreased of the light illuminated to the pixel region 7a. Accordingly, as compared to the case of focusing based on an enhanced or the ideal image-forming system, illumination efficiency can be enhanced in the pixel region 7a because of the increased amount of the illumination light to the pixel region 7a at the allowable angle or smaller.

Meanwhile, by mounting such an illuminator device, a projector 1 can be obtained that is high in illumination efficiency and contrast.

In concerned with the paraxial magnification, allowable angle and focal length of the non-spherical lens 6, design is made on the basis of a paraxial magnification m₁, allowable angle θ₁ and focal length f₁ of the non-spherical lens. Therefore, precise values can be obtained without the necessity of designing a paraxial magnification, allowable angle and focal length for a non-spherical lens 6, from the beginning.

Exemplary embodiments of the invention are not limited in technical scope to the above exemplary embodiment but exemplary modifications can be added suitably within the range not departing from the spirit and scope of exemplary embodiments of the invention.

Although the exemplary embodiment explained the non-spherical lens 6 to converge collimated light in a manner covering the pixel region 7a of the liquid-crystal device 7, the collimated light can be converged to within a range broader than the range of the pixel region 7a, as shown in FIG. 7. This makes it possible to impinge light upon all the pixels of the pixel region 7a without fail because of a sufficient illumination margin t1, t2 taken to the pixel region 7a.

What is claimed is:

1. An illuminator device, comprising:
a light source to emit light to be irradiated to an irradiation plane;
a first optical system provided between the light source and the irradiation plane to make the light emitted from the light source into collimated light; and
a second optical system provided between the first optical system and the irradiation plane to converge the collimated light to the irradiation plane such that aberration occurs on an image of the collimated light in a predetermined region of the irradiation plane.

2. The illuminator device according to claim 1, the second optical system being allowed to converge the collimated light so that the aberration can occur over a broader range than the predetermined region.

3. The illuminator device according to claim 1, the aberration being at least one of negative spherical aberration and introvert coma aberration.

4. The illuminator device according to claim 1, the second optical system being a lens designed to incline a major plane thereof at least around an optical axis thereof.

5. The illuminator device according to claim 1, the optical system including the first and second optical systems being a telecentric optical system.

6. A method of designing a non-spherical lens to converge light, emitted from a light source and collimated, to an irradiation plane, the method comprising:
designing a non-spherical form such that aberration occurs on an image of the collimated light in a predetermined region of the irradiation plane.

7. The method of designing a non-spherical lens according to claim 6, further including:
forming a spherical lens having a predetermined paraxial magnification, allowable angle and focal length; and
deforming the spherical lens so that aberration can occur in an image based on the collimated light converged, in a predetermined region of the irradiation plane.

8. The method of designing a non-spherical lens according to claim 7, the deforming the spherical lens including deforming the spherical lens to incline a major plane of the spherical lens and deforming the spherical lens in a manner of returning the inclination of the major plane at a periphery of the deformed spherical lens.

9. A non-spherical lens designed according to the spherical lens designing method according to claim 7.

10. A projector, comprising: the illuminator device according to claim 1.
